(19) United States
(12) Patent Application Publication
(10) Pub. No.: US 2017/0356481 A1
(43) Pub. Date: Dec. 14, 2017

(54) Method and Apparatus for Producing a Synthetic Semi-Static Tensile Member

(71) Applicant: Richard V. Campbell, Havana, FL (US)

(72) Inventor: Richard V. Campbell, Havana, FL (US)

(21) Appl. No.: 15/616,107

(22) Filed: Jun. 7, 2017

Related U.S. Application Data
(60) Provisional application No. 62/347,121, filed on Jun. 8, 2016.

(51) Int. Cl. F16B 7/04; D07B 1/16; D07B 5/00; D07B 1/02

(52) U.S. Cl. CPC F16B 7/0426; D07B 1/02; D07B 1/16; D07B 5/005; D07B 2201/104

(57) ABSTRACT

A structure for a semi-static tensile member and a method for producing the semi-static tensile member. A tensile member is prepared by attaching terminations to an assembly of synthetic filaments. The tensile member is then attached to a loading apparatus that subjects the tensile member to a pre-defined loading process. The tensile member is thereby conditioned to a stable length. A bend restricting device is attached to the cable assembly proximate the point where the synthetic strands exit the termination and enter the freely-flexing portion of the cable. The bend restricting device is configured to permit periodic inspection of the cable in the region it covers.

### CROSS-REFERENCES TO RELATED APPLICATIONS

This non-provisional patent application claims the benefit of an earlier-filed provisional application. The first provisional application was assigned Ser. No. 62/347,121. It listed the same inventor.

### STATEMENT REGARDING FEDERALLY SPONSORED RESEARCH OR DEVELOPMENT

Not Applicable.

### MICROFICHE APPENDIX

Not Applicable

### BACKGROUND OF THE INVENTION

### 1. Field of the Invention

This invention relates to the field of tensile strength members such as multi-stranded synthetic cables. More specifically, the invention comprises devices and methods for creating a synthetic tensile member having a fixed and stable length where inspection of critical areas is facilitated.

### 2. Description of the Related Art

The term “tensile member” encompasses a very broad range of known devices, including steel rods, braided wire ropes, slings, etc. These devices have for many years been made using steel. For a fixed installation—such as a bridge stay—a relatively rigid rod may be used. For a more mobile installation—such as the rigging on the boom of a crane—braided wire rope may be used. Steel tensile members have been mass produced for over one hundred years and the properties of these tensile members are very well understood. For example, it is well understood how to manufacture a steel tensile member to a precise overall length.

Braided wire ropes may need to be “set” or “bedded” when they are first assembled. This process involves applying tension to tighten the interwoven nature of the strands within the rope. An initial “stretch” will occur, after which a wire rope remains in the “set” state. Significantly, the amount of set needed is predictable and well understood. It is therefore possible to create a wire rope that is “short” by a calculated amount so that when the wire rope is set it will lengthen by a known amount and wind up being the proper length.

A termination must generally be added to a tensile member in order to transmit a load into or out of the tensile member. A termination is most commonly affixed to the end of a tensile member, thought it can be affixed to an intermediate point as well. In this context, the term “termination” means a structure that is affixed to the tensile member to transmit a load to or from the tensile member.

As stated previously, wire rope is an example of a steel tensile member. A hook or loading eye is often added to wire rope. The hook or loading eye in this context is a termination. Such prior art terminations generally include a socket. A length of the wire rope is placed within the socket and “upset” into an enlarged diameter. The upset portion is then potted into the socket using molten lead or—more recently—a strong epoxy. Once the potted portion solidifies, the end of the wire rope is locked into the socket and the termination is thereby permanently affixed.

Prior art terminations are also affixed to wire rope using friction-based devices. One example, is a “spike-and-cone” termination, in which the individual wire strands are clamped between adjacent surfaces to affix a termination to an end of a wire rope. Another common method is an “eye splice” in which a length of the wire rope is passed around a thimble and woven back into itself.

In recent years materials much stronger than steel have become available for use in the construction of cables and other tensile strength members. Many different materials are used for the filaments in a synthetic cable. These include DYNEEMA, SPECTRA, TECHNORA, TWARON, KEVLAR, VECTRAN, PBO, carbon fiber, nano-tubes, and glass fiber (among many others). In general the individual filaments have a thickness that is less than that of human hair. The filaments are very strong in tension, but they are not very rigid. They also tend to have low surface friction. These facts make such synthetic filaments difficult to handle during the process of adding a termination and difficult to organize. The present invention is particularly applicable to terminations made of such high-strength synthetic filaments, for reasons which will be explained in the descriptive text to follow. While the invention could in theory be applied to older cable technologies—such as wire rope—it likely would offer little advantage for that application. Thus, the invention is not really applicable to wire rope and other similar cables made of very stiff elements.

The present invention is applicable to many different types of tensile members (not just cables). However, because cables are a very common application and because the inventive principles will be the same across the differing types of tensile members, cables are used in the descriptive embodiments. Some terminology used in the construction of cables will therefore benefit the reader's understanding, though it is important to know that the terminology varies within the industry and even varies within descriptive materials produced by the same manufacturer. For purposes of this patent application, the smallest individual component of a cable is known as a “filament.” A filament is often created by an extrusion process (though others are used). Many filaments are grouped together to create a strand. The filaments are braided and/or twisted together using a variety of known techniques in order to create a cohesive strand. There may also be sub-groups of filaments within each strand. As the overall cable size gets larger, more and more layers of filament organization will typically be added. The strands are typically braided and/or twisted together to form a cable. In other examples the strands may be purely parallel and encased in individual surrounding jackets. In still other examples the strands may be arranged in a “cable lay” pattern that is well known in the fabrication of wire ropes.

The inventive principles to be disclosed may be applied to an individual strand. They may also be applied to an entire cable made up of many strands. Thus, the invention may be applied to a completed tensile member and it may be applied to a component of an overall tensile member before the component is placed into the assembly.

FIGS. 1-4 provide some background materials to aid the reader's understanding. FIG. 1 depicts a common cable construction in which twelve individual strands 12 are braided together to form a unified cable 10. The strands may slip over one another to some extent. The overall diameter of the cable will also vary when tension is first applied. These phenomena are significant, as will be explained subsequently.

Each strand 12 contains many, many individual filaments (perhaps millions). A termination may be attached to such a cable in many ways. FIG. 2 shows a similar cable—though this example has a simpler helical construction—with a termination 36 attached. Anchor 18 in this example is a radially symmetric component with an expanding central passage 19. A length of the cable is placed in this expanding internal passage and splayed apart. Potting compound is introduced into the passage in a liquid state. The potting compound is any substance which transitions from a liquid to a solid over time (such as an epoxy). The potting compound hardens to form potted region 20. Once the potted region is formed, anchor 18 is locked to the end of cable 10 and a termination 36 is thereby created.

In other examples the cable will be locked to the anchor without the use of a potting compound. Those skilled in the art will know that frictional devices (such as a “spike-and-cone” system) can be used to lock the anchor to the cable.

FIG. 3 provides an example with a more complex organization. This cable assembly includes twelve individual strands 12. An anchor 18 is affixed to the end of each strand 12. Collector 22 includes twelve receivers—each of which is configured to receive an anchor 18. The anchors are connected to collector 22 and a group of attachment features 23 are used to connect the collector to a larger assembly. The “termination” in this context will include the anchors, the collector, and the other hardware attached to the collector. Examples of such assemblies are disclosed in more detail in copending U.S. patent application Ser. No. 13/578,664

The present invention is particularly applicable to semi-static tensile members. The term “semi-static tensile member” means a tension-carrying element that is carrying a load between two relatively fixed points. The tensile member does not pass over a pulley, or sheave (as would be the case with a lifting cable on a crane). However, this does not mean that the element is immobile. The phrase “semi-static” is used because the tensile member is expected to flex and move dynamically.

FIG. 4 provides a good example of a semi-static tensile member. Boom 100 is the fixed boom assembly on a dragline crane. Four cables 10 are anchored between attachment points in the cab assembly and the end of the boom. A termination 36 is provided on the end of each cable. Each of the terminations is connected to the boom. During operation, the length of each of these cables is not customarily changed. However, as the drag bucket operates the boom swings through an arc. The moving bucket also places enormous tensile loads on the four cables. As a result, the cable sway and flex. The tension also rises and falls regularly. Harmonic motion may be established as well. Thus, the four cable shown are “semi-static tensile members.”

The boom application of FIG. 4 is obviously a critical one. If one of these cables break, at best the dragline crane will be shut down for an extended period. At worst the boom may fail catastrophically. It is customary to inspect such cables for wear and fatigue at regular intervals. Thus, inspectability is an important feature in the design.

Also important is fact that the four cables shown must maintain a stable length. If one of the cables stretches, then the other three cables will receive a disproportionate share of the overall load. Producing synthetic tensile members with a consistent and predictable overall length is presently a serious industry challenge. The problems result from one or more of the following factors:

1. The mechanical properties of synthetic filaments vary from batch to batch. While this is true of more traditional materials, the variance is synthetic materials is much greater;

2. Most strands or cables must be created by braiding together thousands to millions of individual synthetic filaments. Two braiding machines may appear to produce a similar result but in fact the properties will vary;

3. There are many steps in fabricating a completed cable assembly using synthetic filaments. Each step introduces additional variations and these variations tend to accumulate;

4. Synthetic filaments must generally be elastically bent and interwoven during the manufacturing process. They are allowed to move and “bed” during use. This bedding or setting process changes both the mechanical properties of a cable as a whole (such as the modulus of elasticity) and the overall length;

5. Synthetic filaments are temperature sensitive. This fact affects stiffness and length in the normal working range; and

6. The addition of a termination to a cable end introduces a considerable slip variable (“setting” or “bedding”) when the cable assembly is first loaded. This variable increases the overall cable length, but the amount of increase has proved to be unpredictable.

All these issues tend to grow more significant as a cable assembly increases in length, strength, and complexity. It is difficult to predict the behavior of larger tensile members due to the accumulation of manufacturing tolerances for all the subcomponents. Further, it may be some time before the length becomes stable as the length of some cable assemblies may continue to grow under tension. If such a tension member is combined in parallel with other tension members, an uneven distribution of the overall load results.

For these reasons, it is not presently common to use synthetic cables where a precise length or stability is important. Exemplary applications include large crane boom stays, bridge stays, and lifting slings. Because of the enormous loads involved, it is common to use a parallel assembly of four or more cables in these applications.

In addition, the wear characteristics of tensile members made of synthetic materials differ from those made of steel materials. In the boom of FIG. 4, significant cable wear occurs where the cable strands exit the relatively rigid termination 36 and enter the freely flexing span. Semi-rigid bend restrictors 102 may be incorporated to ease this transition. However, the presence of the bend restrictors prevents the inspection of the cable right where it most needs to be inspected. The present invention seeks to remedy this problem by providing a bend restrictor that facilitates inspection.

### BRIEF SUMMARY OF THE PRESENT INVENTION

The present invention comprises a structure for a semi-static tensile member and a method for producing the semi-static tensile member. A tensile member is prepared by attaching terminations to an assembly of synthetic filaments. The tensile member is then attached to a loading apparatus that subjects the tensile member to a pre-defined loading process. The tensile member is thereby conditioned to a stable length. A bend restricting device is attached to the cable assembly proximate the point where the synthetic strands exit the termination and enter the freely-flexing portion of the cable. The bend restricting device is configured to permit periodic inspection of the cable in the region it covers.

### BRIEF DESCRIPTION OF THE SEVERAL VIEWS OF THE DRAWINGS

FIG. 1 is an elevation view, showing a multi-stranded cable having a non-parallel construction.

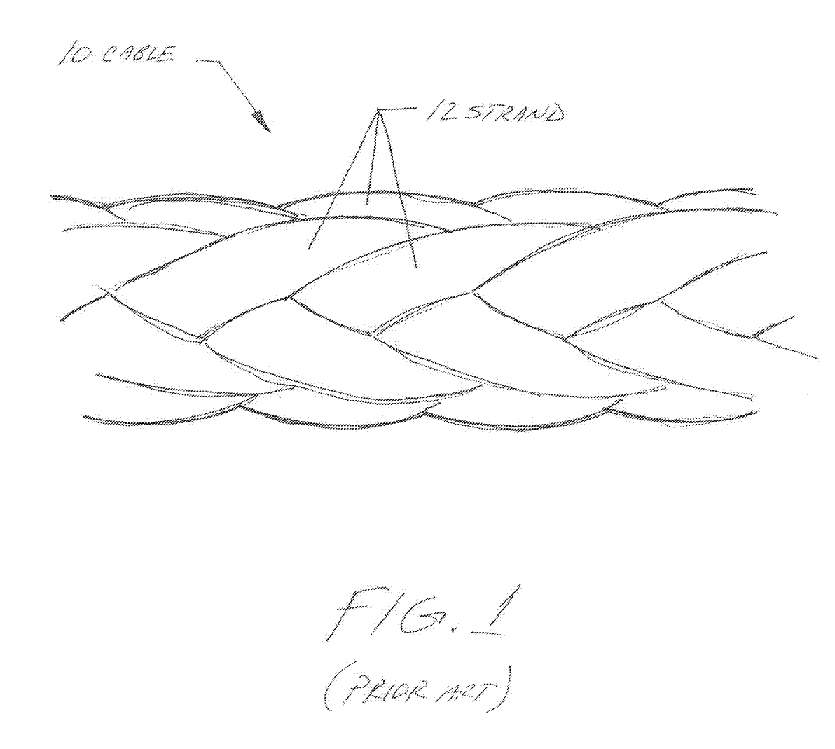

FIG. 2 is a sectional elevation view, showing one way in which a termination can be attached to a cable.

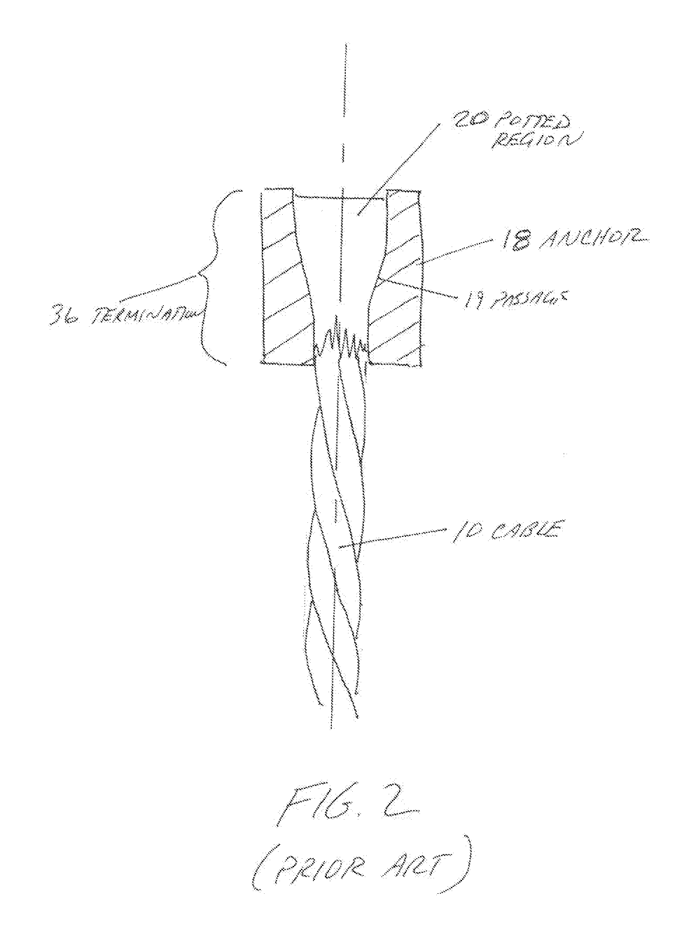

FIG. 3 is a perspective view, showing a cable termination in which multiple anchors are attached to a collector.

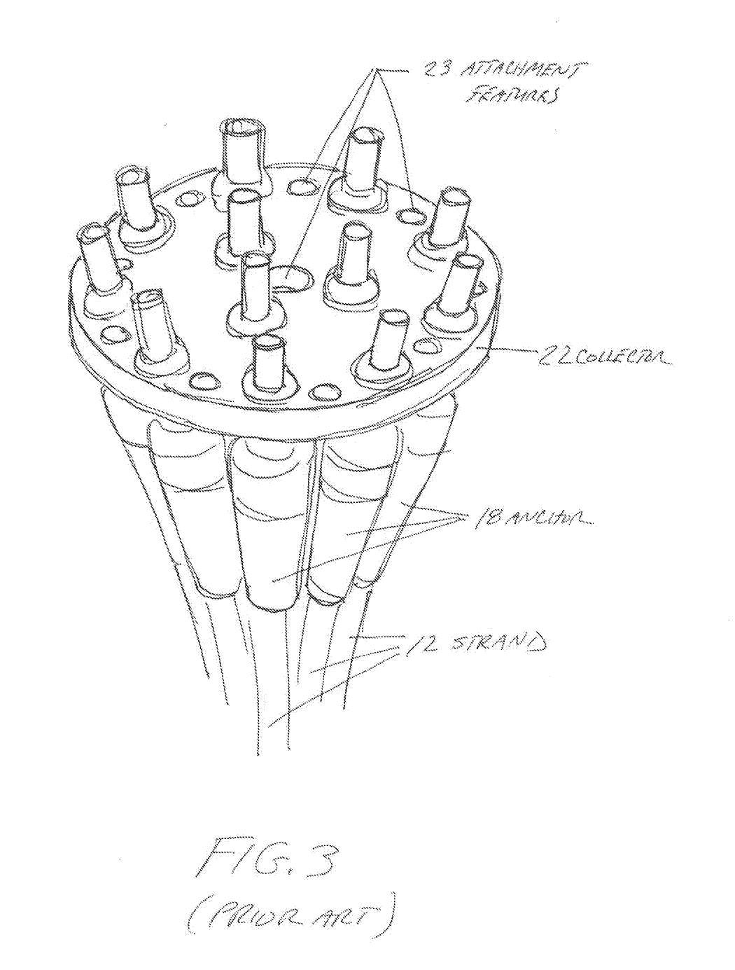

FIG. 4 is a perspective view, showing a parallel cable assembly used to support a boom in a dragline crane.

FIG. 5 is an elevation view, showing a tensioning rig employed in the present invention.

FIG. 6 is a sectional elevation view, showing the application of a bend restrictor to a termination.

FIG. 7 is an exploded perspective view, showing how the bend restrictor can be removed to reveal an inspection region.

FIG. 8 is an elevation view, showing the use of a measuring tape to measure a diameter within the inspection region.

FIG. 9 is a plot showing applied tension over time.

### REFERENCE NUMERALS IN THE DRAWINGS

10 cable

12 strand

18 anchor

19 passage

20 potted region

22 collector

23 attachment features

28 jacket

36 termination

38 loading fixture

40 static fixture

45 first attachment reference

47 second attachment reference

100 boom

102 bend restrictor

104 jacket clamp

106 bend restrictor half

108 mounting hole

110 threaded receiver

112 clamp receiver

114 bolt

116 inspection region

118 bolt flange

120 band clamp

122 measuring tape

124 flange

126 bolt receiver

### DETAILED DESCRIPTION OF THE INVENTION

A cable is a good example of a semi-static tension member. An exemplary cable made according to the present invention will generally have a first termination on its first end and a second termination on its second end. It is important to precondition such a cable after it is made in order to establish a known and stable overall length.

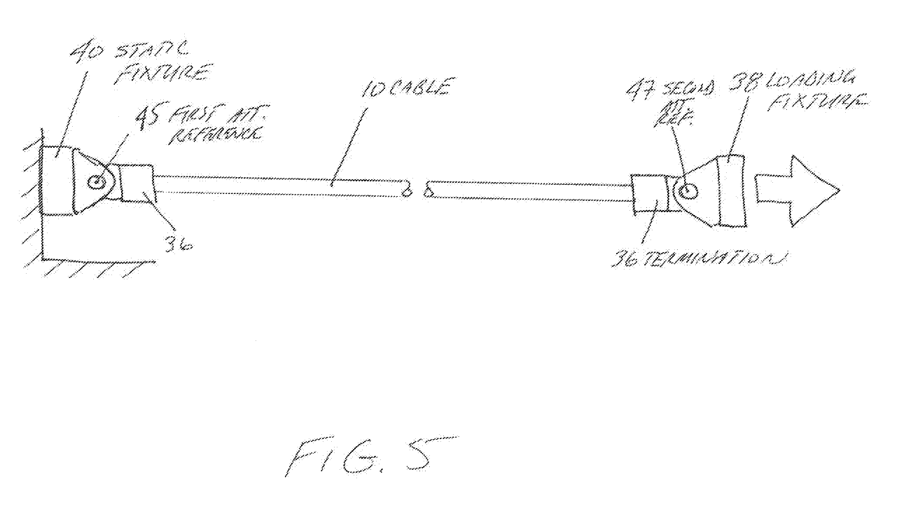

FIG. 5 shows a synthetic cable assembly created by adding a termination 36 to each end of cable 10. The term “synthetic” in this context should be understood to encompass cables made of 100% synthetic filaments as well as hybrid cables made up of a mix of synthetic filaments and conventional metallic filaments.

The first termination is connected to static fixture 40 by a pin located at first attachment reference 45. The second termination is attached to loading fixture 38 by a pin located at second attachment reference 47. A predetermined tension profile is then applied through loading fixture 38.

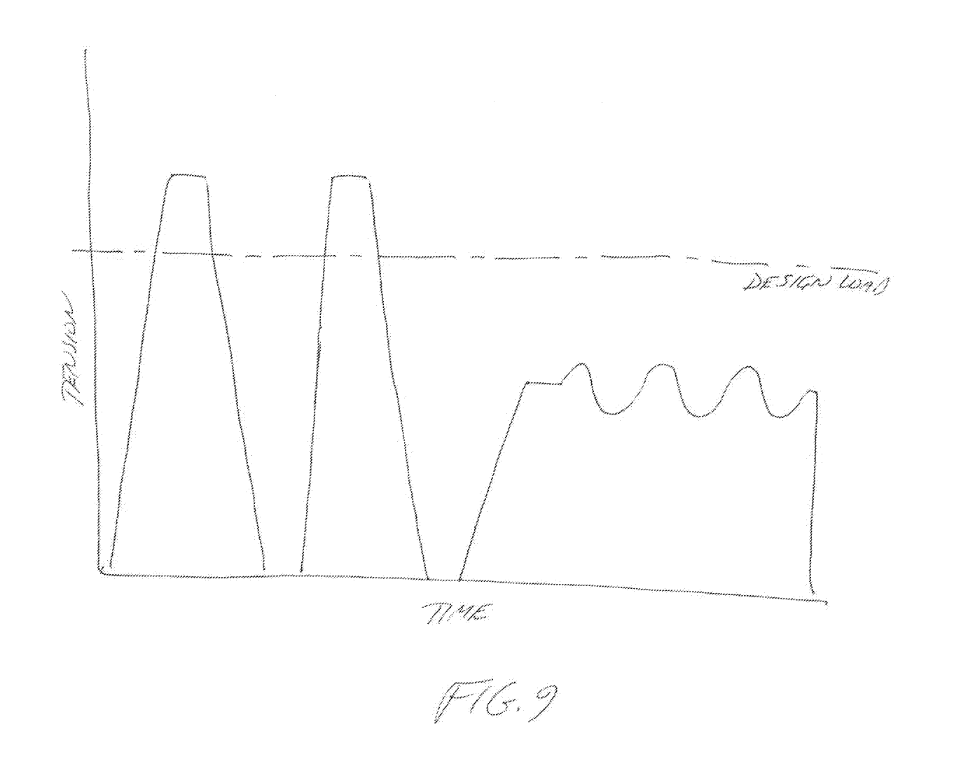

This tension profile may assume many forms, but it will generally include multiple pulls. FIG. 9 depicts an exemplary tension profile. The “design load” represents the maximum tension the cable assembly is expected to see in its upcoming installation. In this example, two ramped “pulls” are made to a level exceeding the design load by 20%. A third pull is established with a sinusoidal component applied over an extended period.

The tension profile is configured to fully “bed” (“set”) both the terminations and the lay of the cable itself. The length of the overall assembly will tend to extend for some period and then stabilize. Once the length has stabilized, the distance between the first attachment reference on the first termination and the second attachment reference on the second termination is determined. This length may then be adjusted as necessary—such as by the addition of a length-adjustment component.

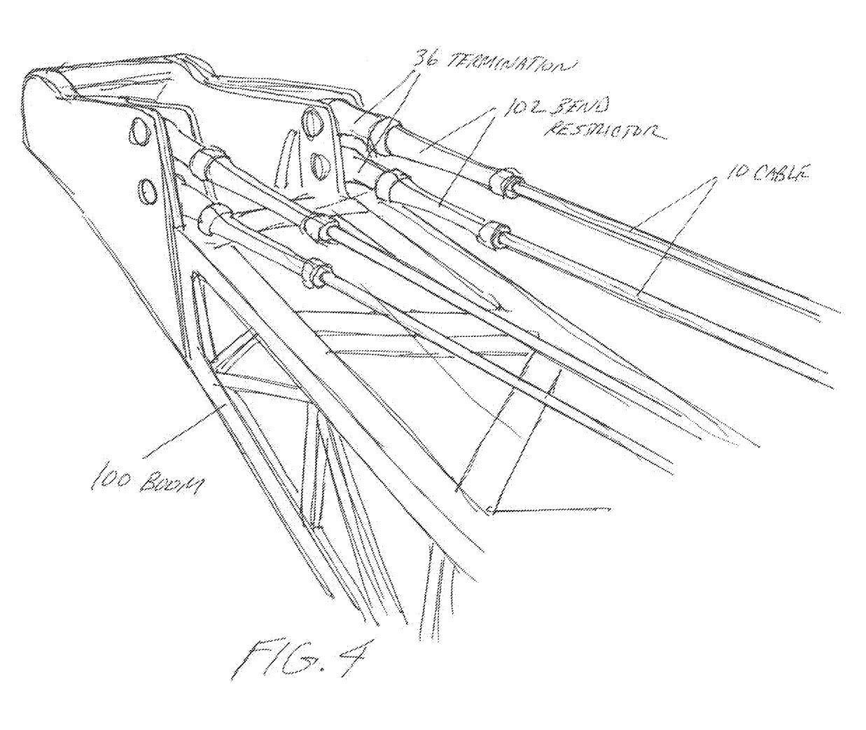

Returning now to FIG. 4, some additional details will be disclosed. The reader will recall that a bend restrictor 102 is added to each termination 36. The bend restrictor reduces the amount of lateral cable flexing at the point the strands of the cable exit the rigid structure of the termination. As the cable bends and flexes, stress concentrates in this area. In order to ensure the continued reliability of the cable, the area of stress concentration should be periodically inspected. The cable cannot typically be removed from service to facilitate the inspection. It usually cannot even be unloaded.

The boom shown in FIG. 4 provides a good example of these issues. The cables are always under load (to support the boom). The terminations illustrated are proximate the boom's tip, which may be 50 meters or more in the air. A service technician must walk up an access catwalk along the boom in order to gain access to the area of bend restrictors 102. It is not practical to carry heavy equipment. Thus, the service technician needs to be able to access the cable and perform an inspection using portable tools.

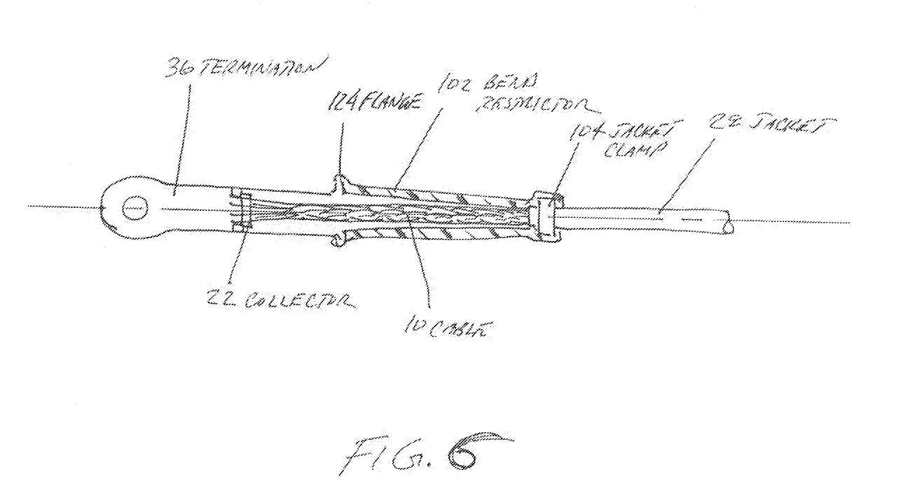

FIG. 6 conceptually illustrates the interaction between termination 36 and bend restrictor 102. Cable 10 is protected over its exposed length (the length outside of the terminations and bend restrictors) by jacket 28. The jacket is typically a tough, extruded polymer. It provides protection against ultraviolet rays, salt corrosion, and mechanical abrasion and cutting forces. However, the cable's strands must generally be exposed in order to attach the strands to a termination. The jacket is therefore discontinued prior to reaching the end of the cable.

In the example of FIG. 6, the end of jacket 28 is secured in place by a compressive jacket clamp 104. Cable 10 continues past the jacket clamp toward termination 36. For this embodiment each of the cable strands is connected to an anchor, and the anchors are attached to collector 22. The collector is then attached to the balance of the termination (This is only shown conceptually in FIG. 6).

Bend restrictor 102 has a proximal end and a distal end. The proximal end of the bend restrictor is firmly attached to flange 124 on termination 36. The distal end of the bend restrictor is attached to jacket clamp 104. The bend restrictor thereby covers arid protects the portion of cable 10 that would otherwise be exposed between the end of the jacket and the start of the termination. Of course, this is the precise area of the cable that needs to be visually inspected from time to time. Accordingly, it is preferable to make the bend restrictor removable. At the same time, the bend restrictor must be sufficiently stiff in its installed state to limit unwanted cable bending.

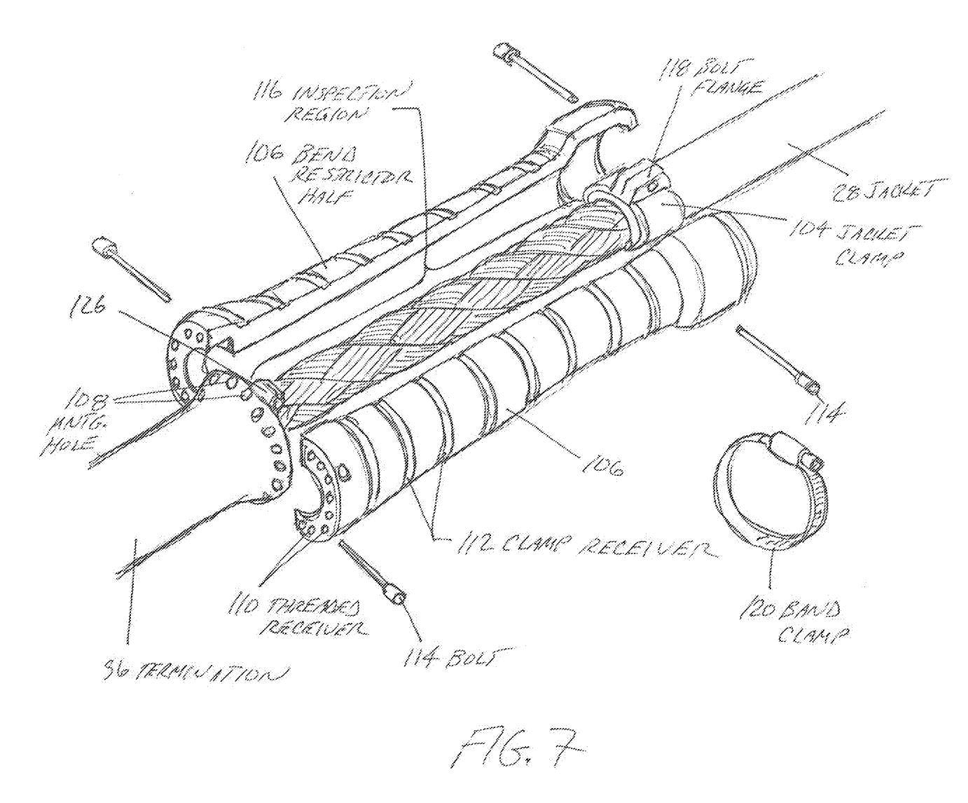

Those skilled in the art will realize that many different mechanical designs could be conceived to achieve these concurrent goals. FIG. 7 shows one particular example. FIG. 7 presents an exploded assembly view. The bend restrictor is divided into toe bend restrictor halves 106. The two bend restrictor halves 106 are shown removed from the cable assembly so that the internal details may be seen.

In the state shown in FIG. 7, inspection region 116 of the cable is fully accessible. The strands and filaments themselves are accessible, as jacket 28 stops at jacket clamp 104. The inspection process will be described after more details of the mechanical assembly are described.

In order to reassemble the exploded assembly depicted in FIG. 7, the user may start by urging the two bend restrictor halves 106 together (The word “may” is used because more than one order of assembly is possible). The user then inserts the four transverse bolts 114. Each bolt 114 passes through a hole in one bend restrictor half and threads into a threaded receiver in the opposite bend restrictor half. The hole in each restrictor half includes a counterbore with a bearing face. The head of each bolt bears against the bearing face of a counterbore as the bolt is tightened—thereby pulling the two bend restrictor halves together.

The two bend restrictor halves are properly positioned with respect to termination 36 by that face that the bolts 114 slide through bolt receiver 126 on the termination and bolt flange 118 on jacket clamp 104. A stronger connection between the termination and the bend restrictor is preferred, however. To that end, numerous bolts are passed through mounting holes 108 in the termination and into threaded receivers 110 on the bend restrictor halves. These bolts create a very strong flange-type connection.

The two bend restrictor halves are preferably made of a very tough yet somewhat elastic material. In the embodiment shown, the two halves are made of molded urethane. While urethane is indeed a tough material, the reader should bear in mind that the tension on the cable will often be enormous and the lateral flexure loads are also quite substantial. These loads will tend to buckle and separate the two bond restrictor halves.

In order to strengthen the assembly, a series of clamp receivers 112 are provided on the exterior surface of the bend restrictor halves. Each clamp receiver is a groove having a rectangular cross section. Once the two halves are united, a band clamp 120 is opened, passed around the two halves, and secured in each clamp receiver. The example shown provides enough receivers to accommodate eight band clamps 120. Once these band clamps are tightened, the assembly becomes much stronger.

The tightened assembly is placed in service and remains in service for a defined interval. Once the interval is completed, the bend restrictor must be opened to facilitate inspection of the cable. The band clamps are removed and the two bend restrictor halves are disassembled. Inspection region 116 is thereby exposed.

The use of a removable bend restrictor has several advantages, including the following:

1. If a portion of the bend restrictor breaks it can be removed from service without having to remove the cable from service;

2. A periodic replacement schedule can be maintained for the bend restrictor so that its failure and an inopportune time is unlikely; and

3. Materials for the bend restrictor having various stiffnesses can be used to tune the overall cable assembly. If as an example resonant coupling is observed, a stiffer material can be used to “uncouple” the terminations and reduce oscillation.

A semi-static tensile member such as shown in FIG. 7 tends to wear in a predictable manner. A hoist cable, for example, may wear at almost any point along its length where the cable passes over a sheave. The semi-static tensile member, on the other hand, will wear proximate its ends (where they interface with the terminations). The majority of such a cable can be encased in a protective jacket. There will be no need to remove the jacket since wear is not anticipated in the vicinity of the jacket.

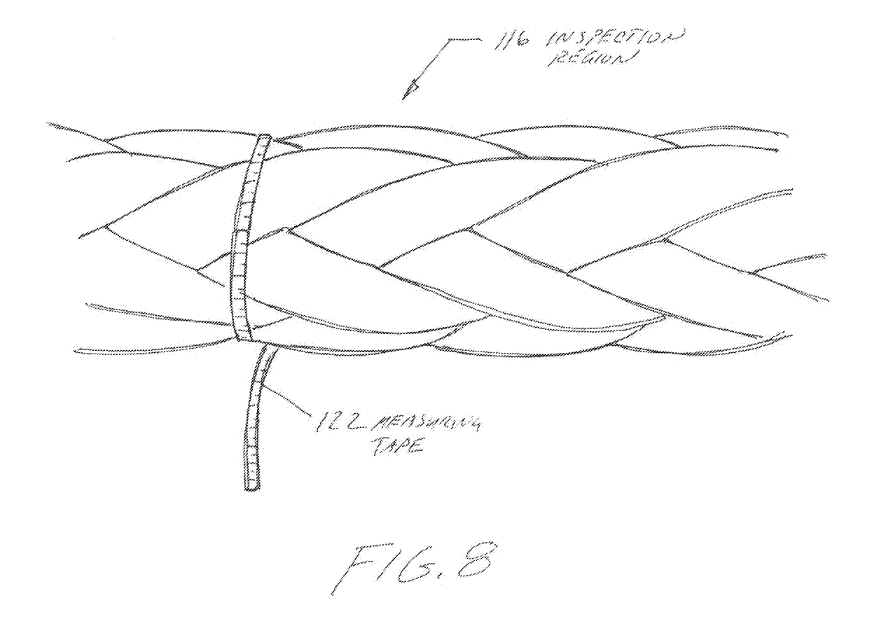

FIG. 8 provides a close view of the cable within inspection region 116. The reader will note that the cable has a non-parallel construction. The advantages of the present invention are greater for a non-parallel construction. Applying any form of twist to the cable strands and fibers increases inward compression when the cable is placed under tension. In fact, the overall diameter of the cable will change considerably when the cable is pre-tensioned as shown in FIG. 5.

Non-parallel cable designs allow some forgiveness in bending as the strands can shift relative to their neighbors. The downside of inward compression is that the wear will commonly begin at the internal contact points between the strands. These wear points will be inside the cable and therefore not observable. However, when configured properly (and when outside-in damage is controlled), this internal wear phenomenon creates a good monitoring opportunity.

A non-parallel cable design is inherently less optimum from a pure tension-carrying standpoint—since each strand is offset from the central axis of the cable as a whole. However, the non-parallel construction allows the strands to shift and move. Space exists between crossing strands and this allows for worn material to migrate. The material that is broken down has ample room to rest between the gaps that always exist in such a structure. This fact is quite important as—when combined with the inward compressive forces inherent in such a cable—a diameter or circumferential measurement is exceptionally valuable.

Once a non-parallel cable is initially set (as shown in FIG. 5), its diameter/circumference becomes quite stable. As the cable wears thereafter, the diameter and circumference will be reduced. Measuring this reduction allows a user to accurately infer the internal war state of the cable. A wear limit can then be determined based on a simple measurement.

In FIG. 8, a circumferential measurement around inspection region 116 is made using a simple measuring tape 122. This measurement can then be logged. It is preferable to mark the cable with bands so that measurement can be made in the same place each time. Several such bands may be provided within inspection region 116. The presence of the band will also tend to indicate the slippage of one strand (as the portion of the band marked on that strand will be pulled out of line).

The reader should recall that the measurements will generally be taken while the cable is still loaded in tension. The inward compression forces will still be present and they will be substantial. These inward compressive forces tend to create a minimum cable diameter that does not include any significant voids. Thus, the measured diameter tends to accurately define the remaining cross section of intact fibers. Of course, a suitable geometric form factor should be used to account for (1) the fact that the individual filaments/fibers themselves have a circular cross section and cannot be perfectly compacted, and (2) the strand grouping cannot be perfectly compacted. Such form factors can be determined and applied.

The measurement of a diameter or circumference can be accomplished in many ways. As stated previously, a simple tape can be used. One may also use camera-based vision systems, lasers, calipers, and other known techniques. The cable manufacturer can establish a minimum criterion that represents the point where a cable should be removed from service. Multiple criteria may be established.

As an example, a cable may have an initial “set” and stable circumference (after pre-tensioning) of 90 cm. A minimum limit of 80 cm is established for this cable. If a future circumference is measured to be below 80 cm, then the operator knows it is time to remove the cable from service. A second “slip” criterion may be established for the same cable. This second criterion specifies establishing a circumferential marking on the cable (in the inspection region) after the pre-tensioning produces a stable state. The slip criterion specifies that if a particular strand shows more than 1.4 cm of longitudinal displacement from a neighboring strand (as observed by a relocation of the original marking) then the cable must be removed from service. Thus, in this example, the cable must be removed from service if either of the two criteria are found.

Although the preceding description contains significant detail, it should not be construed as limiting the scope of the invention but rather as providing illustrations of the preferred embodiments of the invention. Those skilled in the art will be able to devise many other embodiments that carry out the present invention. Thus, the language used in the claims shall define the invention rather than the specific embodiments provided.

Having described my invention, I claim:

1. A synthetic cable termination system, comprising:
a. a cable having a first end and a second end, said cable including a non-parallel assembly of strands wherein the majority of each of said strands is made up of synthetic filaments;
b. a termination having a proximal end and a distal end;
c. wherein said termination is attached to said first end of said cable;
d. wherein said first end of said cable lies between said proximal end of said termination and said distal end of said termination, with said proximal end of said termination being closer to said second end of said cable than said distal end of said termination;
e. a protective jacket overlying an exterior surface of said cable;
f. said protective jacket including a jacket end, with said jacket end being offset from said proximal end of said termination in a direction leading toward said second end of said cable, thereby exposing an inspection region of said cable lying between said jacket end and said proximal end of said termination;
g. a first bend restrictor portion, removably secured to said termination;
h. a second bend restrictor portion, removably secured to said first bend restrictor portion and said termination; and
i. whereby said first and second bend restrictor portions completely cover said inspection region when said first and second bend restrictor portions are secured to said termination.

2. The synthetic cable termination system as recited in claim 1, wherein:
a. said first bend restrictor portion is a half bend restrictor portion;
b. said second bend restrictor portion is a half bend restrictor portion; and
c. said first and second bend restrictor portions are made of a tough and flexible polymer.

3. The synthetic cable termination system as recited in claim 2, wherein said first and second bend restrictor portions are made of urethane.

4. The synthetic cable termination system as recited in claim 1, wherein:
a. said jacket is connected to said cable by a jacket clamp located proximate said cable end; and
b. said first bend restrictor portion is removable secured to said jacket clamp.

5. The synthetic cable termination system as recited in claim 2, wherein:
a. said jacket is connected to said cable by a jacket clamp located proximate said cable end; and
b. said first bend restrictor portion is removable secured to said jacket clamp.

6. The synthetic cable termination system as recited in claim 3, wherein:
a. said jacket is connected to said cable by a jacket clamp located proximate said cable end; and
b. said first bend restrictor portion is removable secured to said jacket clamp.

7. The synthetic cable termination system as recited in claim 1 further comprising a plurality of band clamps secured around said first and second bend restrictor portions.

8. The synthetic cable termination system as recited in claim 7, wherein said first and second bend restrictor portions include a plurality of clamp receivers, wherein each of said clamp receivers is configured to receive one of said band clamps.

9. The synthetic cable termination system as recited in claim 2 further comprising a plurality of band clamps secured around said first and second bend restrictor portions.

10. The synthetic cable termination system as recited in claim 9, wherein said first and second bend restrictor portions include a plurality of clamp receivers, wherein each of said clamp receivers is configured to receive one of said band clamps.

11. A synthetic cable termination system, comprising:
a. a cable having a first end and a second end, said cable including a non-parallel assembly of strands wherein the majority of each of said strands is made up of synthetic filaments;
b. a termination having a proximal end and a distal end;
c. wherein said termination is attached to said first end of said cable;
d. wherein said first end of said cable lies between said proximal end of said termination and said distal end of said termination, with said proximal end of said termination being closer to said second end of said cable than said distal end of said termination;
e. a protective jacket overlying an exterior surface of said cable;
f. said protective jacket including a jacket end, with said jacket end being offset from said proximal end of said termination in a direction leading toward said second end of said cable, thereby exposing an inspection region of said cable lying between said jacket end and said proximal end of said termination;
g. a first bend restrictor portion, removably secured to said termination;
h. a second bend restrictor portion, removably secured to said first bend restrictor portion and said termination;
i. whereby said first and second bend restrictor portions completely cover said inspection region when said first and second bend restrictor portions are secured to said termination; and
j. wherein said bend restrictor portions are sufficiently stiff to inhibit lateral deflection of said cable in said inspection region.

12. The synthetic cable termination system as recited in claim 12, wherein:
a. said first bend restrictor portion is a half bend restrictor portion;
b. said second bend restrictor portion is a half bend restrictor portion; and
c. said first and second bend restrictor portions are made of a tough and flexible polymer.

13. The synthetic cable termination system as recited in claim 12, wherein said first and second bend restrictor portions are made of urethane.

14. The synthetic cable termination system as recited in claim 11, wherein:
a. said jacket is connected to said cable by a jacket clamp located proximate said cable end; and
b. said first bend restrictor portion is removable secured to said jacket clamp.

15. The synthetic cable termination system as recited in claim 12, wherein:
a. said jacket is connected to said cable by a jacket clamp located proximate said cable end; and
b. said first bend restrictor portion is removable secured to said jacket clamp.

16. The synthetic cable termination system as recited in claim 13, wherein:
a. said jacket is connected to said cable by a jacket clamp located proximate said cable end; and
b. said first bend restrictor portion is removable secured to said jacket clamp.

17. The synthetic cable termination system as recited in claim 11 further comprising a plurality of band clamps secured around said first and second bend restrictor portions.

18. The synthetic cable termination system as recited in claim 17, wherein said first and second bend restrictor port ions include a plurality of clamp receivers, wherein each of said clamp receivers is configured to receive one of said band clamps.

19. The synthetic cable termination system as recited in claim 12 further comprising a plurality of band clamps secured around said first and second bend restrictor portions.

20. The synthetic cable termination system as recited in claim 19, wherein said first and second bend restrictor portions include a plurality of clamp receivers, wherein each of said clamp receivers is configured to receive one of said band clamps.
